(19) United States
(12) Patent Application Publication
(10) Pub. No.: US 2014/0058750 A1
(43) Pub. Date: Feb. 27, 2014

(54) SYSTEM, PROCESSING DEVICE AND METHOD TO PROVIDE A SUMMARY OF PATIENT HEALTHCARE INFORMATION TO AN ELECTRONIC HEALTH RECORD FROM A HEALTH PLAN PROVIDER

(71) Applicants: Edward J. Fotsch, Sausalito, CA (US); Debra Del Guidice, Sausalito, CA (US)

(72) Inventors: Edward J. Fotsch, Sausalito, CA (US); Debra Del Guidice, Sausalito, CA (US)

(73) Assignee: PDR NETWORK, LLC, Montvale, NJ (US)

(21) Appl. No.: 13/595,686

(22) Filed: Aug. 27, 2012

(51) Int. Cl. G06Q 50/24

(52) U.S. Cl. 705/3

(57) ABSTRACT

A system to provide a summary of patient healthcare information to a EHR during a patient visit is provided. Electronic information indicating that a healthcare provider entered a diagnosis into the EHR of the patient is received by a processing device. Electronic information indicating a health plan associated with the patient is also received by the processing device. A request for information is provided to request a summary of patient healthcare information in response to the diagnosis and the health plan. In an alternate embodiment, a request for information is provided when a patient's EHR is accessed by a healthcare provider and the patient has certain characteristics. The request for information to request the summary of patient healthcare information is transmitted to another processing device having healthcare information of the patient. The summary of patient healthcare information is then received and transmitted to the EHR.

### BACKGROUND

1. Field

The present technology relates to providing a summary of patient healthcare information.

2. Description of Related Art

Healthcare providers rely on incomplete information when delivering care, largely dependent on patient information in the form of the clipboard and oral history, and healthcare provider information in existing charts and referral information. This lack of information leads to suboptimal results, including morbidity, mortality, patient injury and provider liability, and results in ongoing additional costs. Potential sources of additional information are challenging (including the advent of Health Information Exchanges, which are nascent with unclear near-term futures), health plans may have data but lack the necessary/affordable healthcare provider connectivity, resulting in health plan—healthcare provider communications that are limited to phone, fax and portals, and information flow back to health plans (in the form of claims) is slow and incomplete.

### DESCRIPTION OF THE DRAWING

FIGS. 1A-B illustrate systems to distribute a summary of patient healthcare information from health plans according to an embodiment.

FIGS. 2A-B illustrate a software architecture of patient summary information software 102a illustrated in FIGS. 1A-B according to an embodiment.

FIGS. 3A-C are flow charts to illustrate a method to distribute a summary patient healthcare information to Electronic Healthcare Records (“EHRs”) according to an embodiment.

FIGS. 4A-B illustrates hardware architectures for providing a summary of patient information according to an embodiment.

FIG. 5A illustrates a web page 500 to enter and display a diagnosis of a patient provided at EHR website or service 110a shown in FIGS. 1A-B according to an embodiment.

FIG. 5B illustrates a web page 510 indicating a health plan patient summary for a patient has been provided at EHR website or service 110a shown in FIGS. 1A-B according to an embodiment.

FIG. 5C illustrates a web page 520 indicating a summary of patient healthcare information provided at EHR website or service 110a shown in FIGS. 1A-B according to an embodiment.

In the drawing, in which like reference numerals indicate similar elements, and in the following description, numerous specific details are set forth as examples in order to provide a thorough understanding of embodiments. It will be obvious, however, to one skilled in the art, that embodiments may be practiced without some or all of these specific details. In other instances, well known process steps or elements have not been described in detail in order not to unnecessarily obscure a particular embodiment.

### DETAILED DESCRIPTION

A system, processing device and method to provide a summary of patient healthcare information to an electronic health record (“EHR”) (a.k.a. Electronic Patient Record (“EPR”) or Electronic Medical Record (“EMR”)) is provided. Electronic information indicating that a healthcare provider entered a diagnosis into the EHR of the patient is received by the processing device. Electronic information indicating a health plan associated with the patient is also received by the processing device. A request for information is provided for a summary of patient healthcare information in response to the diagnosis and the health plan. In an alternate embodiment, a request for information is provided when a patient's EHR is accessed by a healthcare provider and the patient has certain characteristics, such as being a female over 50 years old, even though a diagnosis was not entered. The request for information may include one or more identifiers, such as a routing identifier, which is transmitted to another processing device having healthcare information of the patient. The summary of patient healthcare information is then received from the another processing device and transmitted to the EHR.

In an embodiment, a summary of patient healthcare information is received and viewed by a healthcare provider during a patient's visit so that the healthcare provider may discuss the summary of patient healthcare information with the patient.

In an embodiment, the summary of patient healthcare information includes one or more diagnosis, tests, treatments, or follow-ups to be performed on the patient.

In an embodiment, the electronic information indicating that a healthcare provider entered a diagnosis into the EHR of a patient includes a patient name, a patient EHR identifier, a diagnosis code, a EHR identifier and a healthcare provider identifier. In an embodiment, the electronic information includes other unique information regarding the patient, such as date of birth (DOB), in order to ensure a patient is matched with a health plan of the patient.

In an embodiment, the electronic information indicating a health plan associated with a patient includes a health plan name, a health plan identifier, a patient name, and a health plan member number.

In an embodiment, the method further comprises comparing the health plan identifier with a plurality of participating health plan identifiers stored in a database before selecting a routing identifier from a respective plurality of routing identifiers stored in the database to include in the request for information, wherein the selecting does not occur when there is not a match between the health plan identifier and one of the plurality of participating health plan identifiers.

A patient summary information processing device to provide a summary of healthcare information of a patient to an EHR is also provided in an embodiment. The patient summary information processing device includes at least one storage device to store a plurality of identifiers used to request a summary of patient healthcare information and at least one processor, coupled to the storage device. The storage device stores executable machine readable instructions for controlling the processor. The processor is operative with the executable machine readable instructions to receive electronic information indicating that a healthcare provider entered a diagnosis into the EHR of the patient and information indicating a health plan associated with the patient. A request for information is provided that includes one or more identifiers, such as a routing identifier. The request for information that requests the summary of patient healthcare information is transmitted to a health plan processing device having healthcare information of the patient. The patient summary information processing device receives the summary of patient healthcare information from the health plan processing device and transmits the summary of patient healthcare information to the EHR.

A system to provide a summary of healthcare information of a patient to a EHR is also provided in an embodiment. The system includes a first, second and third processing device. The first processing device provides an EHR patient chart for a patient to a healthcare provider. The second processing device stores the summary of healthcare information of the patient. The third processing device provides the summary of healthcare information of the patient to the first processing device from the second processing device in response to a diagnosis being entered into the EHR at the first processing device. The diagnosis code is transferred from the first processing device to the third processing device after the diagnosis code is entered into the EHR. The third processing device requests the summary of healthcare information of the patient from the second processing device in response to receiving the diagnosis code from the first processing device.

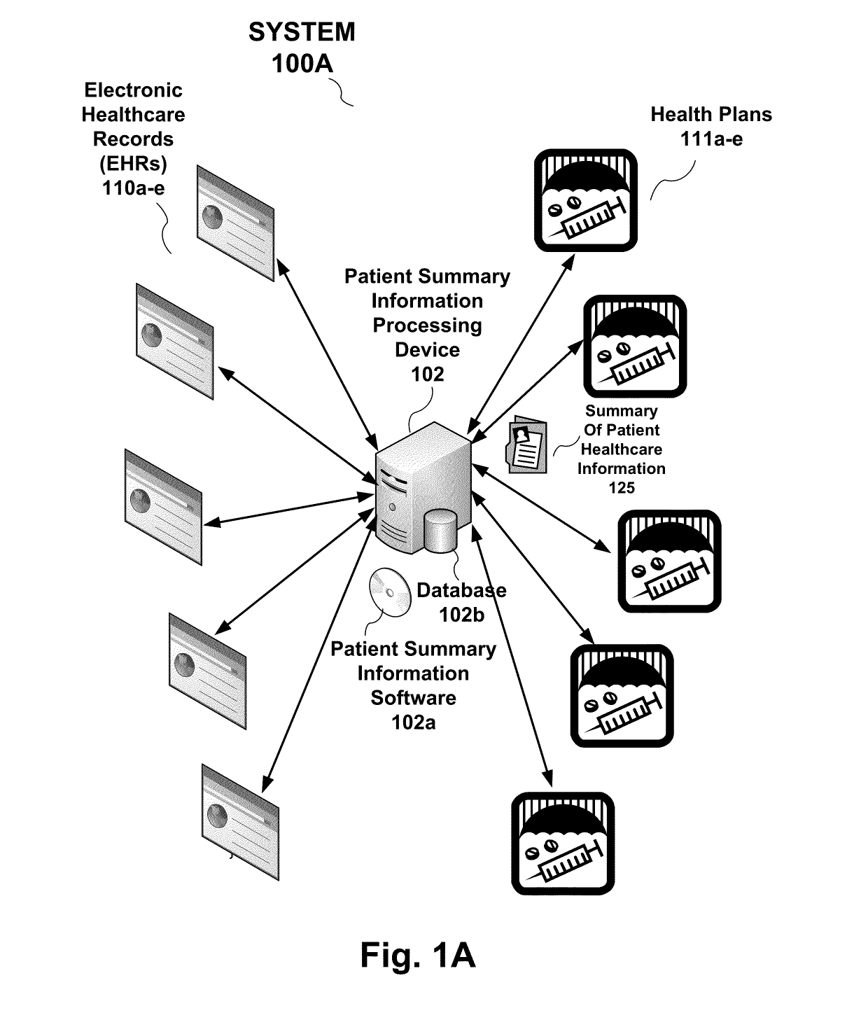

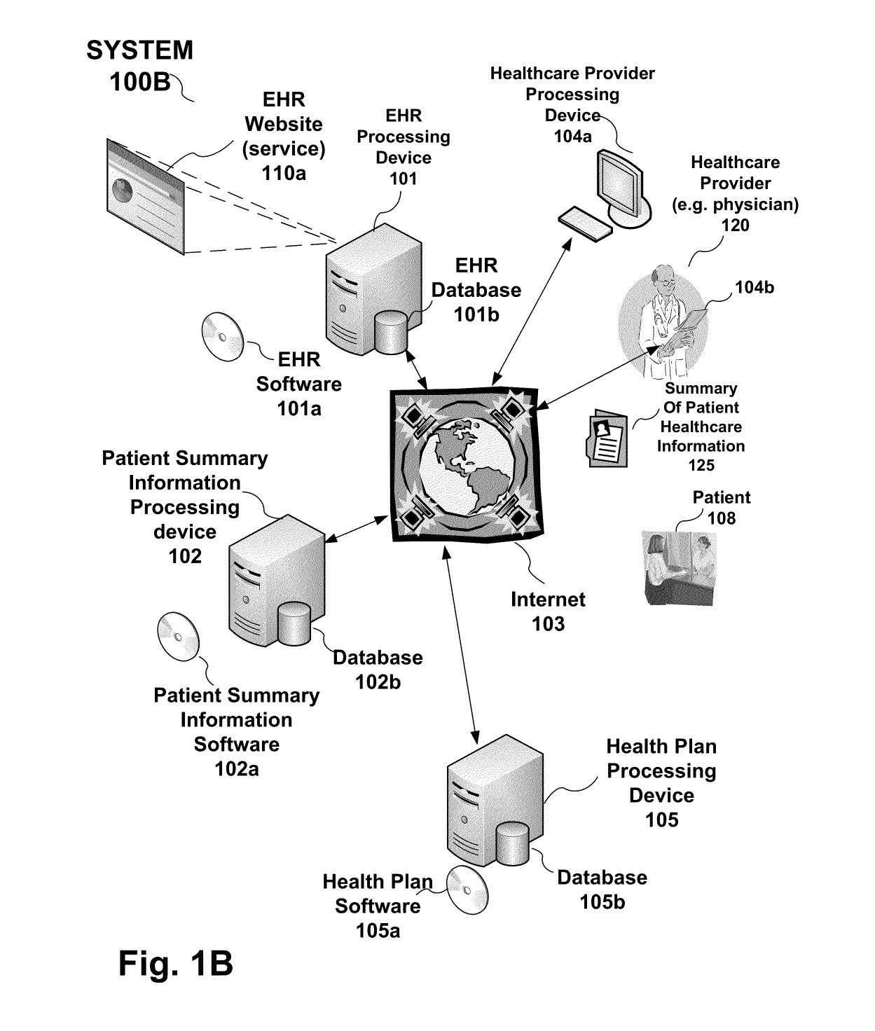

FIGS. 1A-B illustrate systems 100A-B to distribute a summary of patient healthcare information from health plans, or entities that manage and/or pay for care, to a healthcare provider 120 according to an embodiment. In particular, FIG. 1A illustrates system 100A that provides a summary of patient healthcare information 125 from one or more health plans 111a-e to one or more EHRs 110a-e via patient summary information processing device 102 and patient summary information software 102a. The summary of patient healthcare information 125 is provided to one or more EHRs 110a-e that is viewable by health care provider 120 after entering a diagnosis for patient 108 in the corresponding EHR as illustrated in FIG. 1B. In an embodiment, patient summary information processing device 102 and patient summary information software 102a provide a request for information that may include one or more identifiers, such as a routing identifier, which is transmitted to one or more health plans 111a-e having healthcare information of a patient 108.

In an alternate embodiment, a summary of patient healthcare information 125 is provided when a patient's 108 EHR is accessed by a healthcare provider 120 and a patient 108 has certain characteristics, such as a being female over 50 years old, even though a diagnosis was not entered. For example, a particular health plan may want all females over 50 years of age to have a mammogram regardless of the diagnosis entered, if any. Thus, the summary of patient healthcare information 125 may include a mammogram test for a female patient that has not recently received one and is over 50 years of age.

In an embodiment, a summary of patient healthcare information 125 is received and viewed by the healthcare provider 120 during a patient's 108 visit so that a healthcare provider 120 may discuss a summary of patient healthcare information 125 with patient 108. In an embodiment, a summary of patient healthcare information 125 is provided within seconds of a healthcare provider 120 opening a patient's 108 EHR or entering a diagnosis of patient 108 into a EHR.

Health Plans 111a-e include, but are not limited to, health insurance companies or carriers, health insurance exchanges, unions, government agencies, employers or an equivalent in embodiments. A health plan generally refers to an entity that finances or reimburses the cost of health services, medication and/or products, and/or manages insurance/care on behalf of a payer. Health plans typically have healthcare information of members or patients.

A healthcare provider 120 may be a Physician, Physician Assistant, or Nurse Practitioner in an embodiment. The terms healthcare provider and physician will be used interchangeably herein. However, it is important to note that the healthcare provider need not be a physician.

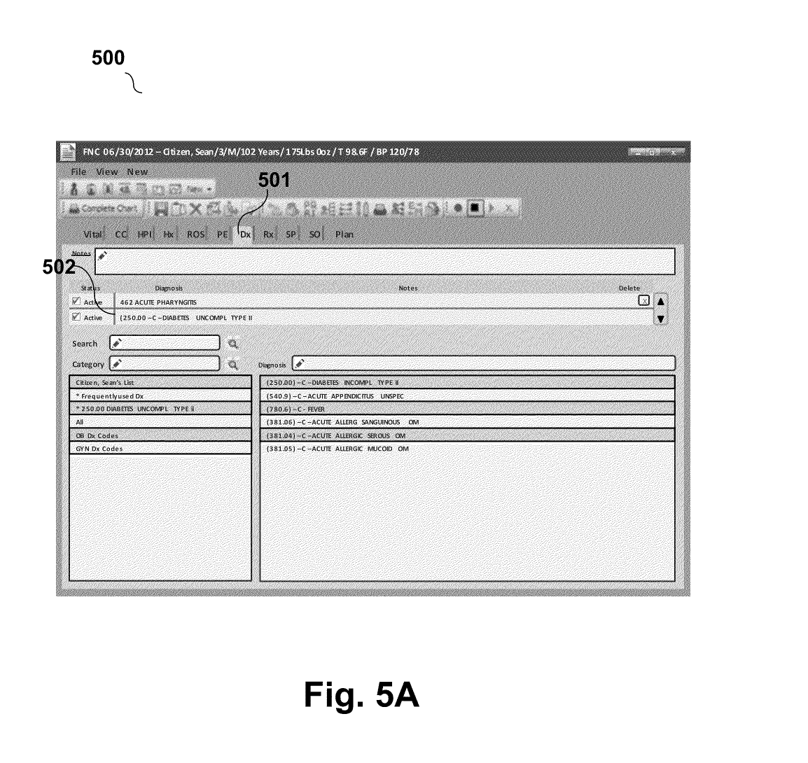

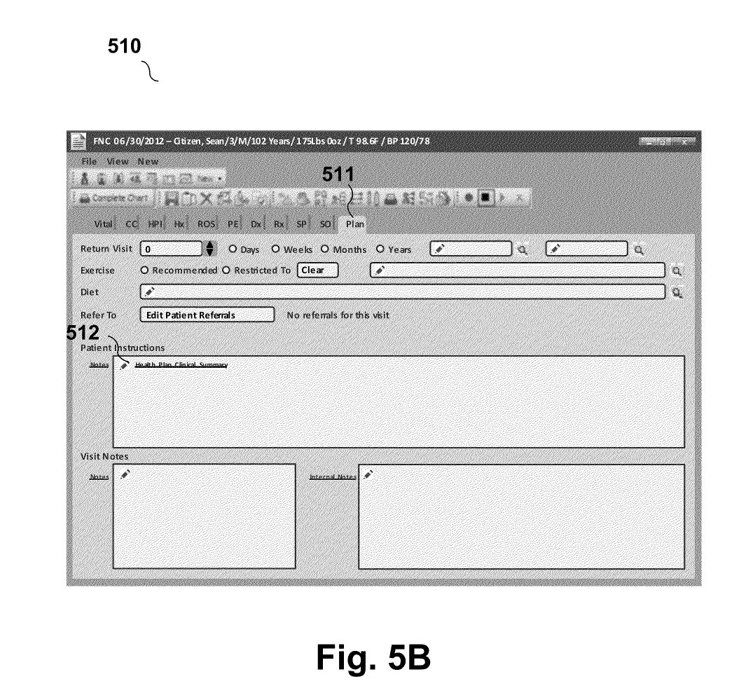

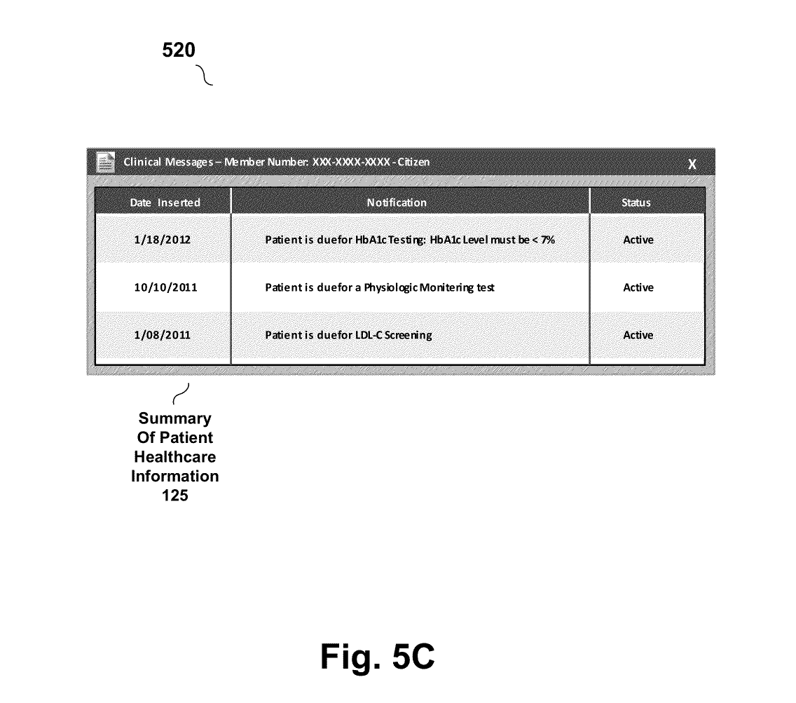

Summary of patient healthcare information 125 may be previously ordered or recommended healthcare treatments or tests for a particular diagnosis, or other important treatments or tests not related to the diagnosis but important to the care of the patient which may be based on patient characteristics, in embodiments. For example, FIG. 5C illustrates a summary of patient healthcare information 125 provided on web page 520 for patient “Citizen” which is viewable at EHR website or service 110a by healthcare provider 120. This exemplary summary of patient health care information 125 is provided to EHR website or service 110a after healthcare provider 120 entered a diagnosis 502 of “Diabetes” on web page 500 in EHR website or service 110a as illustrated in FIG. 5A. In this summary of patient healthcare information 125, patient Citizen is due for “HbAlc Testing,” “Physiological Monitoring test,” and “LDL-C Screening” when diagnosed with “Diabetes.” In an embodiment, web page 520 includes information as to which test or treatments are paid or subsidized by the health plan.

A health plans 111a-e may want to encourage or incentivize a patient with a particular diagnosis to undergo a particular treatment or test. These recommended treatments or tests may increase the likelihood that a patient's condition won't become worse or complicated, and therefore lead to more costly treatments. However, one particular, health plan may pay for a particular treatment while another health plan does not and a healthcare provider would not necessarily know what test or treatment has been previously ordered (or recommended for that diagnosis) and whether it is paid for or subsidized by a particular health plan.

Providing a summary of patient healthcare information 125 to a healthcare provider 120 while the provider 120 is consulting with a patient 108 provides numerous unexpected results. Healthcare providers have more relevant data to work with, within the patient's chart, and can assist in closing some or all of the “gaps in care”. Healthcare providers can discuss the treatment or test recommendations with the patient at the point of care. Patients are able to make informed decisions as to the treatments or tests, or other recommendations in the care plan. Patients are able to know whether the test or treatments are paid for or subsidized by a health plan. Health plans may encourage the patients to undergo free treatments or tests that will increase costs to health plans; yet, avoid more costly treatments if the condition worsens or is not treated. One or ordinary skill in the art would not expect a health plan to encourage a member to consume healthcare benefits or services that would lead to a current reduction in profits. Also as healthcare benefits for a particular health plan are typically received by facsimile machine or mail and out of the healthcare provider's typical work flow, there is not an opportunity for the healthcare provider to discuss and educate a patient as to what healthcare benefits are available for a particular diagnosis at a current consolation.

FIG. 1B illustrates a system 100B where healthcare provider 120 views and accesses a EHR website or service 110a via healthcare provider processing device 104a and EHR processing device 101 and EHR software 101a. In an alternate embodiment, a healthcare provider 120 accesses a EHR of a patient or a EHR service 110a provided on a private local or wide area network that can transfer information to and from the Internet 103. In an embodiment, healthcare provider 120 uses a processing device 104b. Health plan processing device 105 and health plan software 105a provide a summary of patient healthcare information 125 to EHR website or service 110a via patient summary information processing device 102 and patient summary information software 102a. Respective databases 101b, 102b and 105b, illustrated as storage devices in FIG. 1B, are accessible by processing devices and software 101/101a, 102/102a and 105/105a.

For convenience and in order to clearly described embodiments, information is described herein as being transferred to and from EHR website or service 101a; however, one of ordinary skill in the art understands that information is actually transferred to and from EHR processing device 101. Similarly, information is described herein as being selected, transmitted or received, for example, by a processing device. One of ordinary skill in the art would understand that the processing device as well as the associated software at least performs such functions, as well as other functions.

In an embodiment, processing devices 101, 102, 104a/b and 105 are coupled to and communicate by way of Internet 103. In embodiments, systems 100A-B may have far greater or fewer processing devices. In embodiments, a processing device may represent multiple hardware components or a network of distributed processing devices or hardware components. Processing devices may be coupled to Internet 103 by way of a wired or wireless connection, singly or in combination.

In embodiments, a processing device may include one or more of a mainframe computer, server, laptop computer, hand-held computer/pad, personal digital assistant, a telephone, a cellular telephone, email device, an information appliance, or an equivalent. In an embodiment, a processing device includes at least one integrated circuit processor that executes machine readable instructions (software) stored on an internal or external storage device.

EHR website or service 110a, in embodiments, is a systematic collection of digital electronic health information about individual patients that is hosted or stored on one or more processing devices and is accessible via the Internet 103 or over a private network by client processing devices. EHRs may include a range of data regarding a patient, including medical history, medication and allergies, immunization status, laboratory test results, radiology images, vital signs, personal stats like age and weight, as well as problem, diagnosis, orders, and notes pertaining to visits. In an embodiment, EHR website 110a is in the form of a collection of web pages. In an embodiment, a web page is a digital document that may be written in Hypertext Markup Language (HTML) or an equivalent.

The HTML document may be accessible via Hypertext Transfer Protocol Secure (HTTPS), a protocol that transfers information from a processing device to another processing device in response to a request. A HTTPS request is included in a TCP/IP message/packet. In particular, a HTTPS request is nested inside a TCP (Transmission

Control Protocol) message which are contained in IP (Internet Protocol) messages which contain information about the destination processing device, the originating processing device, the ports the message belongs, and the lifespan of the message. While an embodiment uses the TCP/IP message/packet protocol, other protocol embodiments may be similarly used for generating similar requests and/or messages between processing devices.

In an embodiment, one or more processing devices in systems 100A-B include a HTML-compatible browser to view HTML web pages. In an embodiment, HTML documents are provided from at least processing device 101 to processing devices 102, 104a-b and 105 in response to a request. HTML provides basic document formatting and allows “links” or “hyperlinks” to other processing devices (or servers) and files. A link such as a Uniform Resource Locator (URL) has a specific syntax that identifies a network path to a server for defining a network connection. Embedded hyperlinks on a given web page can be used to find information related to the given web page. By clicking on a hyperlink in one web page, the user can display another related web page or even invoke a related software program.

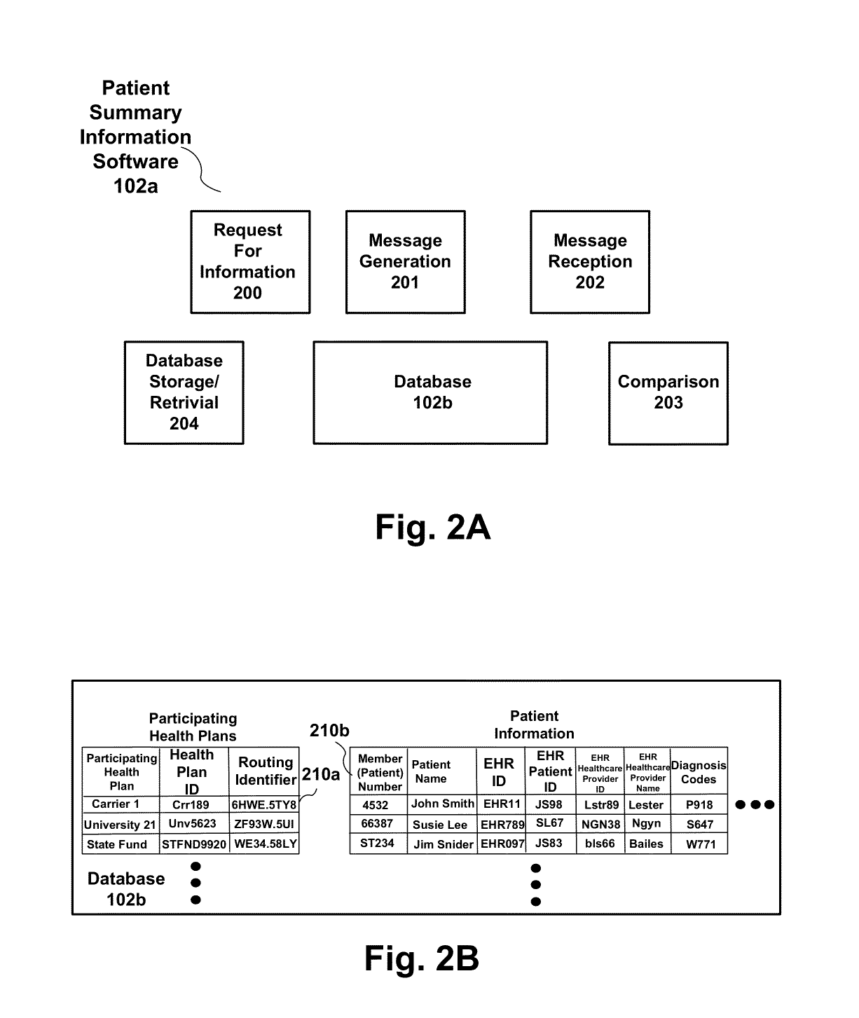

FIGS. 2A-B illustrate a software architecture of patient summary information software 102a illustrated in FIGS. 1A-B according to an embodiment.

FIG. 2A illustrates software components of patient summary information software 102a that may be executed on patient summary information processing device 102, shown in FIGS. 1A-B, to provide summary of patient healthcare information 125 to EHR website or service 110a. In an embodiment, patient summary information software 102a includes machine/computer readable or executable instructions. In an embodiment, patient summary information software 102a is stored in an article of manufacture, such as a computer readable medium that may be removable from or included in a processing device. For example, patient summary information software 102 may be stored in a storage device such as a magnetic hard disk, an optical disk, a floppy disk, Compact Disk Read-Only Memory (CD-ROM) as illustrated in FIG. 1, Random Access Memory (RAM), Read-Only Memory (ROM), Electrically Erasable Programmable Read-Only Memory (EEPROM) or other readable or writeable data storage technologies, singly or in combination. In alternate embodiments, patient summary information software 102a may be transferred by an electronic signal or downloaded by way of the Internet using wired and/or wireless connections.

Similarly, databases 101b, 102b and 105b may be likewise stored in an article of manufacturer, such as a storage device.

In embodiments, FIG. 2A illustrates software components that may include a software program, software object, software function, software subroutine, software method, software instance, script or a code fragment, singly or in combination. In embodiments, software components illustrated in FIG. 2A have functions described in detail below.

Request for Information 200 is responsible for creating a request for information message (or request message) or packet to be output to the health plan processing device to request a summary of patient healthcare information after it is confirmed that the health plan is participating. In an embodiment, a request message includes at least a health plan routing identifier and request for information identifier. In an embodiment, the request for information identifier includes patient information and a diagnosis code. Request for Information 200 also selects an appropriate routing identifier from a plurality of stored routing identifiers associated with respective health plans or health plan processing devices. Request for information 200 stores the appropriate routing number in a request or request message after it is determined that the received health plan is participating or valid. In an embodiment, comparison 203 described below determines whether a received health plan is participating or valid. In an embodiment, a routing identifier is not selected unless a diagnosis code is also received. In an alternate embodiment, a routing identifier is selected even if a diagnosis code is not received. In an embodiment, Request for Information 200 creates a unique request identifier (ID) that is included in each request message. The created request ID is also stored in database 102b.

Message Generation 201 is responsible for generating one or more TCP/IP messages to at least processing devices 101 and 105 via Internet 103. In an embodiment, message generation 201 includes TCP/IP software. In an embodiment, a request message is included in a TCP/IP message.

Message Reception 202 is responsible for receiving one or more TCP/IP messages from at least processing devices 101 and 105 via Internet 103. In an embodiment, message reception 202 includes TCP/IP software. In an embodiment, electronic information is received from processing devices 101 and 105 by way of a TCP/IP message.

Comparison 203 is responsible for determining whether a received health plan and health plan ID is valid or participating. Comparison 203 does this by comparing the received health plan and/or health plan IDs with a plurality of participating health plan names and health plan IDs stored in database 102b. In an alternate embodiment, comparison 203 also compares a stored request ID in database 102b with a received request ID from health plan processing device 105 as described below.

Database Retrieval/Storage 204 is responsible for retrieving and storing information in database 102b.

Database 102b stores and maintains data for patient healthcare summary information processing device 102. In an embodiment, the stored information includes 1) information regarding participating health plans and 2) patient information or data associated with a request for information to obtain a summary of patient healthcare information as illustrated in FIG. 2B.

In an embodiment, information regarding participating health plans are stored in plurality of records, such as a record 210a, and includes a plurality of participating health plan names, associated participating health plan IDs and associated routing identifiers or information.

In an embodiment, patient information may be obtained from an EHR and is used in providing a request for information sent to a health plan. In an embodiment, patient information for each patient is stored in a plurality of records, such as a record 210b. In an embodiment, patient information includes a member (patient) number in the health plan, patient name and a data of birth, a EHR identifier that identifies the EHR that initiated the request, a EHR identifier for the patient, a EHR healthcare provider ID of the health care provider that entered the diagnosis (or opened the patient EHR) or EHR healthcare provider ID, the EHR healthcare provider name and diagnosis code entered by the healthcare provider.

In an embodiment, database 102b also includes information indicating whether a health plan returned a requested summary of patient healthcare information (not shown) and information indicating that the EHR received the requested summary of patient healthcare information (not shown). In an embodiment, a summary of patient healthcare information is received (and temporarily stored) by patient summary information processing device 102 before being forwarded to an initiating EHR. In an embodiment, a summary of patient healthcare information is not stored in database 102b.

FIG. 2B illustrates records 210a and 210b that include participating health plan information and patient information. In an embodiment, a record is a data structure that includes a plurality of fields of contiguous bits of information. While FIG. 2B illustrates data structures stored in database 102b, one of ordinary skill in the art would understand that database 102b includes other data as well. In alternate embodiments, other types of data structures may be used. In an embodiment, record 210a includes fields of information associated with a participating health plan from which summary of patient healthcare information 125 may be obtained. For example, in the first row under in the “Health Plan” column, the “Carrier 1” health plan has contiguous fields including the “Health Plan ID” which is “Crr189” and an associated “Routing Identifier” “6HWE.STY8” for that the “Carrier 1” health plan. In an embodiment, a routing identifier is stored in a request message and used to at least partially identify where to direct the message or where the associated health plan processing device is located. Record 210b stores information obtained from a EHR and includes, but is not limited to, member (patient) number, patient information, EHR ID, EHR patient ID, EHR healthcare provider ID, and diagnosis code in an embodiment.

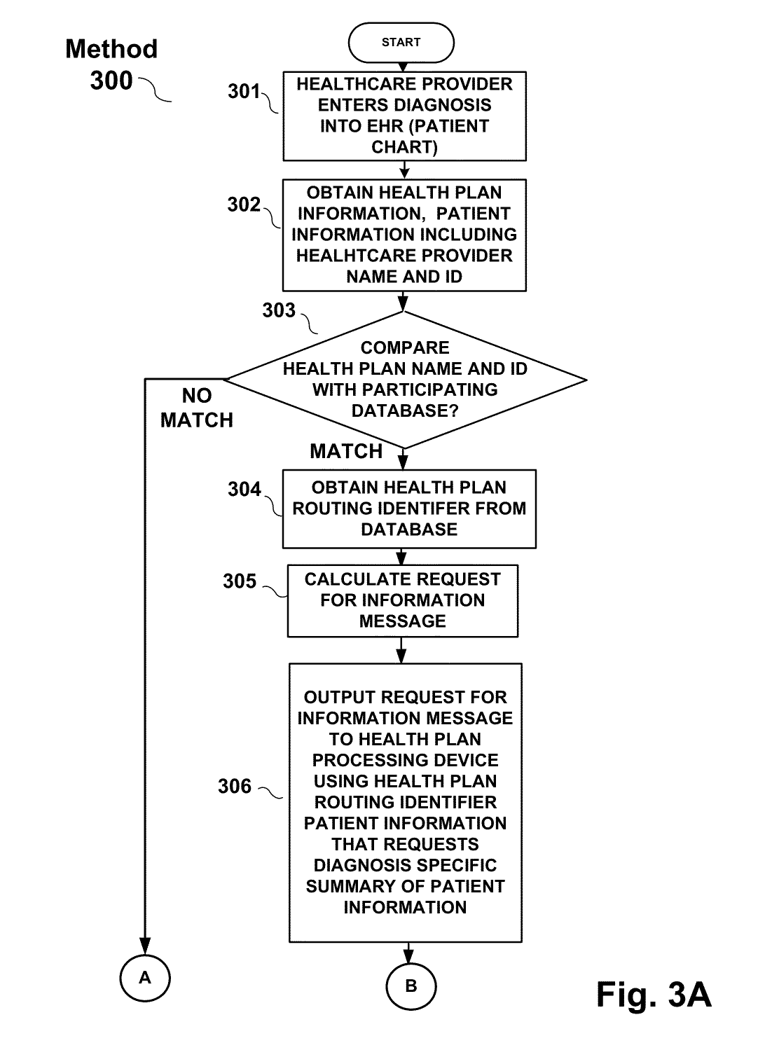

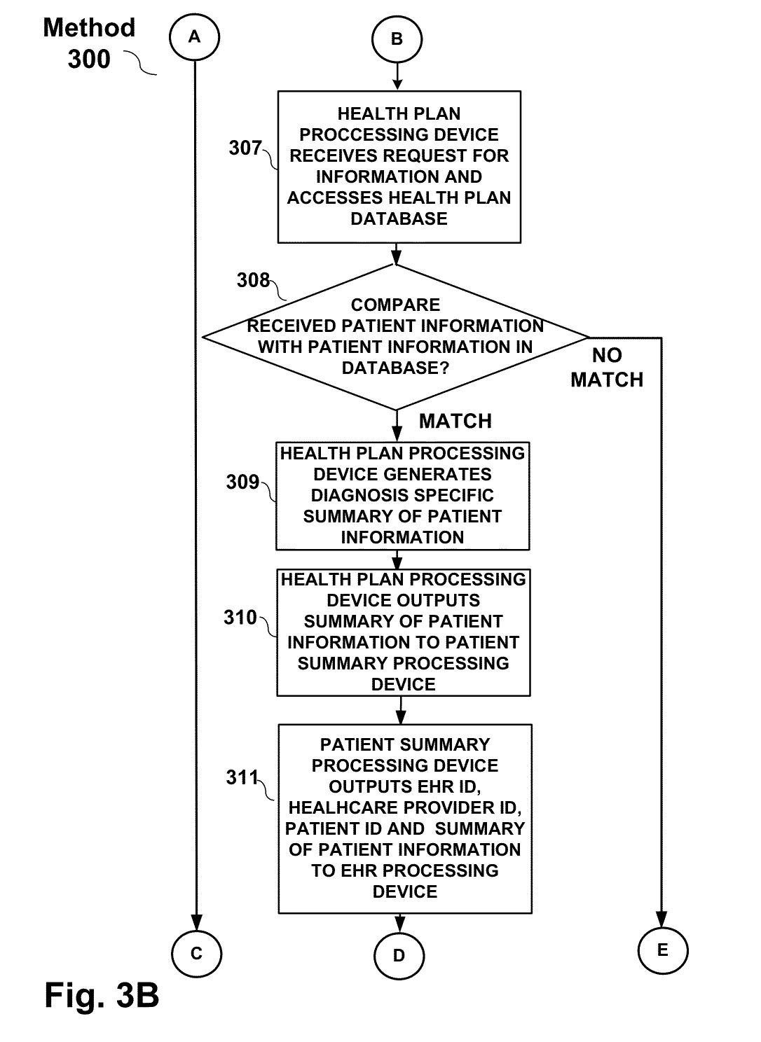

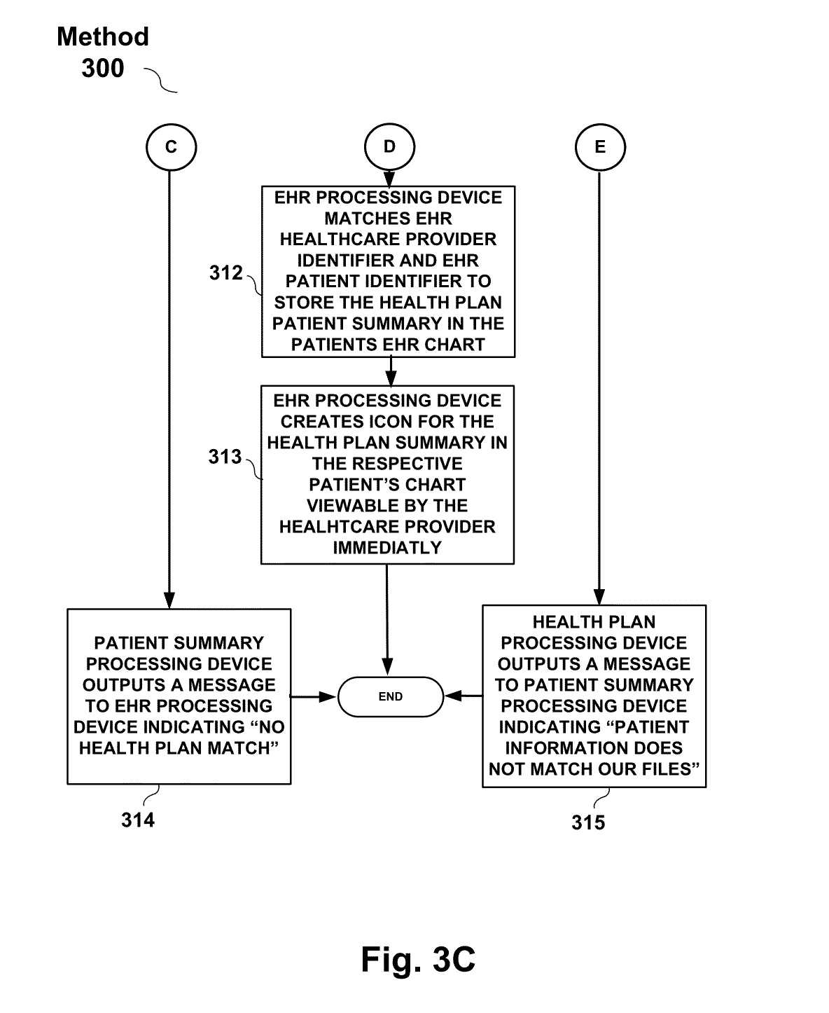

FIGS. 3A-C are flow charts to illustrate distributing patient healthcare summary information to an EHR according to an embodiment. FIGS. 3A-C illustrate method 300 according to embodiments. In an embodiment, FIGS. 3A-C illustrate the operation of systems shown in FIGS. 1A-B. As one of ordinary skill in the art would appreciate, FIGS. 3A-C illustrate logic boxes or steps for performing specific functions. In alternate embodiments, more or fewer logic blocks or steps are used. In an embodiment, a logic block or step may represent at least partial execution of a software component as well as execution of a hardware/processor operation or user operation, singly or in combination. For example, many logic blocks in FIGS. 3A-C represent the execution of software components illustrated in FIG. 2A on patient summary information processing device 102 shown in FIGS. 1A-B.

Method 300 begins by a healthcare provider entering a diagnosis into a patient chart in the EHR as illustrated by logic block 301. For example, healthcare provider 120 illustrated in FIG. 1B enters a diagnosis into a web page 500 as illustrated in FIG. 5A. In an embodiment, web page 500 is included in an EHR website or service 110a as illustrated in FIGS. 1A-B. In an embodiment, web page 500 is a patient chart in EHR website 110a for patient “Sean Citizen.” In particular, a healthcare provider 120 enters a “250.00” diagnosis code 402 for “Diabetes Uncompl Type II” under the diagnosis tab 501.

As described above in an alternate embodiment, a healthcare provider 120 does not enter a diagnosis code, but merely access a EHR of a patient 108 that has certain characteristics.

Health plan information and patient information is obtained from EHR website or service 110a as illustrated in logic block 302. In an embodiment, this information is obtained from EHR website or service 110a patient chart database as illustrated by EHR database 101b in FIG. 1B. In an embodiment, health plan information includes health plan name, health plan ID and routing identifier. In an embodiment, patient information includes member (patient) number, patient first name, middle name, last name, date of birth, EHR ID, EHR patient ID, EHR healthcare provider name and EHR ID an diagnosis code. In an embodiment, Message Reception 202 of patient summary information software 102a receives this information from EHR processing device 101.

Logic block 303 then illustrates determining whether the received health plan and health plan ID are participating health plans. In an embodiment, the received health plan and health plan ID obtained from EHR database 101b is compared to participating health plans and health plan IDs stored in patient summary database 102b. In an embodiment, Comparison 203 in patient summary information software 102a illustrated in FIG. 2A performs this comparison function. If a match occurs, control transitions to logic block 304; otherwise, control transitions to logic block 314 which represents patient summary processing device 102 outputting a message to EHR website or service 110a indicating “No Health Plan match” is available and method 300 ends.

When a valid or participating health plan match occurs, logic block 304 represents obtaining the associated health plan routing identifier from database 102b. In an embodiment, Request for Information shown in FIG. 2A performs this function

A unique request for information message is then calculated using the health plan routing identifier as illustrated in logic block 305. The unique request for information message requests a diagnosis-specific summary of patient healthcare information and also includes the patient information as illustrated in FIG. 2B. In an embodiment, Request for Information 200 in patient summary information software 102a performs this function. In an embodiment, a request for information message includes a unique request ID that is also stored database 102b.

In an alternate embodiment, a request for information message is calculated or generated in response to electronic information received from a EHR website or service 110a for a patient with particular characteristics.

Logic block 306 illustrates sending the request for information message prepared in logic block 305 from patient summary information processing device 102 to health plan processing device 105. In an embodiment, Message Generation 201 in patient summary information software 102a performs this function.

Logic block 307 illustrates the health plan processing device 105 and health plan software 105a obtaining patient information from database 105b upon reception of the request for information message from patient summary information processing device 102. In an embodiment, health plan processing device 105 receives patient information or clinical information for patients covered under respective healthcare plans and stores this information in database 105b before logic block 307 is performed. This patient information stored in database 105b may be received from one or more sources.

Logic block 308 then illustrates determining whether the received patient information is valid or the received patient information by health plan processing device 105 is included in a current health plan. In an embodiment, patient information in the received request for information message is compared to valid patients and health plans stored in health plan database 102b. When a match occurs, control transitions to logic block 309; otherwise, control transitions to logic block 315 which represents health plan processing device 105 outputting a message to patient summary information processing device 102 indicating “Patient Information does not match our files” and method 300 ends.

Logic blocks 309 and 310 illustrate health plan processing device 105 generating a diagnosis specific summary of patient healthcare information requested for the selected patient and outputting the summary of patient healthcare information to patient summary information processing device 102. In an embodiment, web page 520 as seen in FIG. 5C illustrates a summary of patient healthcare information for patient “Citizen.” For example, patient “Citizen” is past due for “LDL-C Screening” on “1/8/2011” along with two other notifications of past due test/treatments. Health plan processing device 105 generated the summary of patient health care information 125 for patient “Citizen” when a diagnosis code was received that indicated that patient “Citizen” has “Diabetes” as illustrated in FIG. 5A and described above. Other important tests/treatments for patient “Citizen” related to the “Diabetes” diagnosis is also provided. For example, a “HbAlc testing” and “Physiologic Monitoring ring” tests shown on web page 520 may have been previously ordered and now may be overdue. In an alternate embodiment, these tests or treatments are recommended when a particular “Diabetes” diagnosis is entered for this particular health plan. In an embodiment, the out of pocket cost to the patient associated with each test or treatment is provided.

In an alternate embodiment, a summary of patient healthcare information is obtained for a patient with particular characteristics by the health plan processing device and not based on a diagnosis code.

In an embodiment, health plan processing device includes the received request ID in the request for information message in the summary of patient healthcare information transmitted to patient summary information processing device 102.

Logic block 311 illustrates patient summary information processing device 102 receiving the above described message from health plan processing device 105 and then sending a corresponding message including the associated EHR ID, EHR healthcare provider ID, EHR patient ID and summary of patient healthcare information to EHR website or service 110a. In an embodiment, patient summary information processing device 102 compares a stored request ID with a received request ID to establish that the requested information has been successfully received.

Logic block 312 illustrates the EHR website or service 110a receiving the above described message from the patient summary of information processing device 102 and matching the EHR ID, EHR healthcare provider ID and EHR patient ID with the EHR ID, healthcare provider IDs and patient EHR IDs stored in database 101b. When a match occurs, the summary of patient healthcare information is attached to or stored with the corresponding patient chart and controls transfers to control block 313. Otherwise, a message is sent to patient summary information processing device 102 for follow-up as to a reason for a failed match.

Logic block 313 illustrate providing an icon by the EHR processing device 101 in the corresponding patient's chart so that a health care provider may click on the icon to obtain the summary of patient healthcare information 125 that was provided by health plan processing device 105 via patient summary information processing device 102. For example, as illustrated in FIG. 5B, an icon 512 and link “Health Plan Clinical Summary” under “Plan” tab on web page 510 at the EHR website 110a is provided. A healthcare provider 120 then may click on the link to view a corresponding summary of patient healthcare information for patient “Citizen”, such as illustrated by web page 520 shown in FIG. 5C. Method 300 then ends.

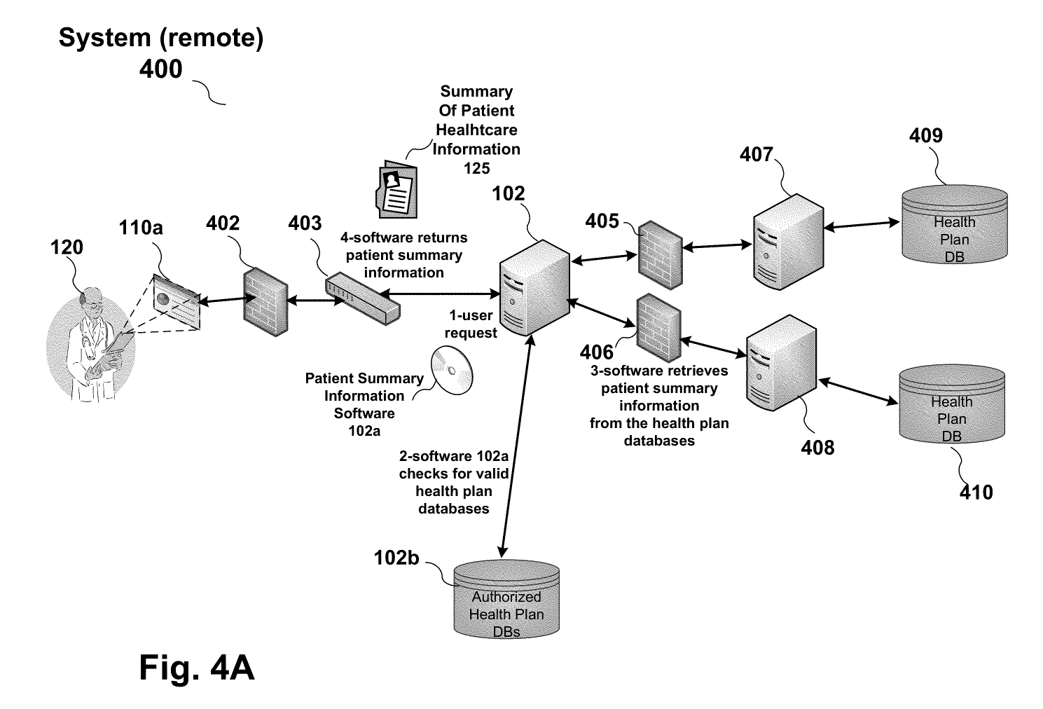

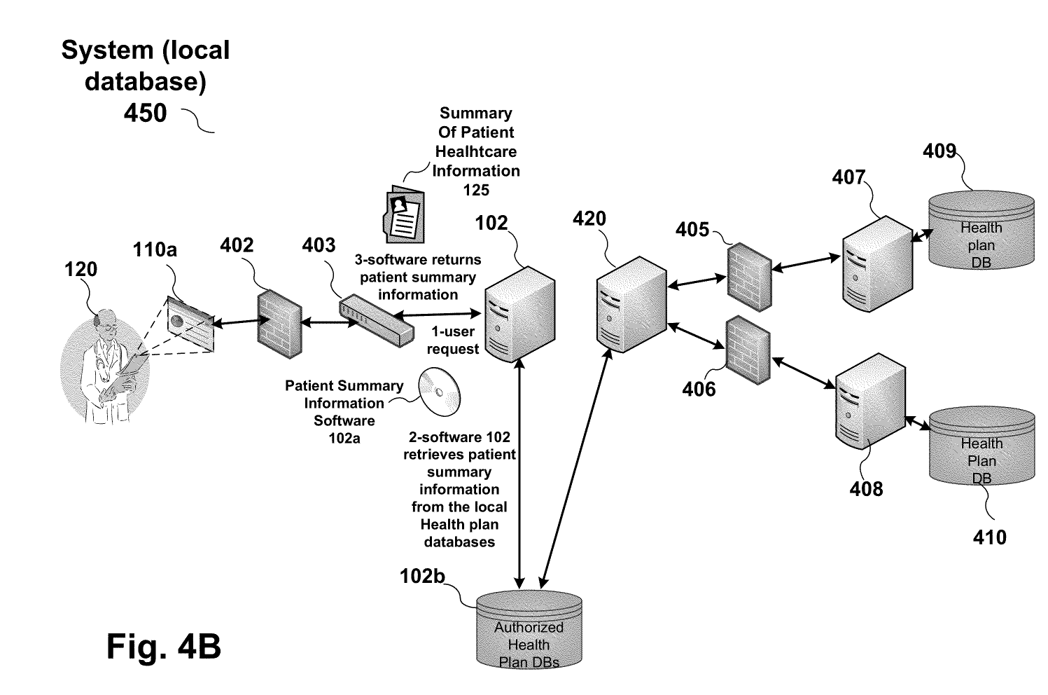

FIGS. 4A-B illustrates hardware embodiments for providing a summary of patient healthcare information 125 to EHR website or service 110. System 400 of FIG. 4A illustrates an embodiment in which patient summary information processing device 102 obtains summaries of patient healthcare information from remote health plan databases 409-410 via health plan processing devices 407-408. FIG. 4B illustrates an alternate embodiment in in which patient summary information processing device 102 obtains summaries of patient healthcare information from a local database 102b via data replicater 420 instead of directly from health plan databases 409 and 410.

In particular, FIG. 4A illustrates that healthcare provider 120 enters a diagnosis into EHR website or service 110 which triggers a request for a summary of patient healthcare information 125 to patient summary information processing device 102 via the Internet 103. In an embodiment, the request for a summary of patient healthcare information is routed through firewall 402 and load balancer 403 before reaching patient summary information processing device 102.

In an alternate embodiment, EHR website or service 110 triggers a request when a healthcare provider 120 accesses a EHR of a patient having particular characteristics.

Patient summary information processing device 102 and software 102a operate under an Application Service Provider (ASP) model. Software is delivered from processing device 102 as services rather than a set of deliverables (s/w packages, executables, CDs, etc.) to processing devices via Internet 103. Software offered using an ASP model may be called On-demand software or Software as a Service (SaaS). For example, access to an application program, such as patient summary information software 102a shown in FIG. 2A, using a standard protocol is provided by patient summary information processing device 102. In an embodiment, patient summary information software 102a is accessed by a web browser on respective processing devices or by special purpose client software stored on the respective processing devices.

In embodiments, patient summary information processing device 102 includes a large number of servers, networking equipment, other processing devices, sub-systems and/or equivalent hardware, designed to support uninterrupted functioning of software components and services. As one of ordinary skill in the art would appreciate, more or less processing devices shown in FIG. 4A-B may be used in alternate embodiments. In embodiments, one or more software components illustrated in FIG. 2A are at least partially stored and/or at least partially executed by patient summary information processing devices 102 illustrated in FIGS. 4A-B. In alternate embodiments, processing devices illustrated in FIG. 4 may be replaced by functionally equivalent software components.

In an embodiment, firewall 402 is software and/or hardware to detect unauthorized users (such as hackers and intruders) and prevent unauthorized users from accessing patient summary information processing device 102.

In an embodiment, load balancer 403 is software and/or hardware, coupled to firewall 402, responsible for providing a single Internet service from multiple servers and spread work among the multiple servers in patient summary information processing device 102.

Upon receiving a request for a summary of patient healthcare information, patient summary information processing devices 102 and software 102a determines whether the request is a valid request as described herein. In other words, patient summary information processing devices 102 and software 102a determines whether the request is for a participating health plan that may be accessed by patient summary information processing devices 102. In an embodiment, patient summary information processing devices 102 and software 102a compares the health plan name and ID received in the request with a plurality of participating health plan names and IDs stored in database 102b. When the request is valid, patient summary information processing devices 102 and software 102a then requests the summary of patient healthcare information 125 from one or more health plan processing devices 407 and 408 with corresponding databases 409 and 410 which stores the patient healthcare information. Each health plan processing device 407 and 408 has a respective firewall 405 and 406 in embodiments. In alternate embodiments, health plan processing devices 407 and 408 have load balancers (not shown).

One or more health plan processing devices 407 and 408 then returns the summary of patient healthcare information 125 to patient summary information processing devices 102 which then forwards it to EHR website or service 110a as described herein.

System 450 illustrated in FIG. 4B operates similar to system 400 described herein except for a local database 102b and replicator 420. Instead of patient summary information processing devices 102 and software 102a requesting summary of patient healthcare information from participating respective health plan processing devices 407 and 408, summary of patient healthcare information for respective patients is replicated by replicator 420. Before a request for a summary of patient healthcare information is made, health plan processing devices copy the summary of patient healthcare information from databases 409 and 410 to replicator 420. Therefore, patient summary information processing devices 102 has to access replicator 420 that has copies of summaries via local database 102b. The summary of patient healthcare information stored in databases 409 and 410 would be periodically synchronized with the copy in replicator 420. Requests for summaries of patient healthcare information may be provided in a faster manner in this embodiment since the information is stored or accessible locally as opposed to having to be requested from remote health plan processing devices 407 and 408.

Although illustrative embodiments are shown and described herein, many variations and modifications are possible which remain within the concept, scope, and spirit of the claims, and these variations would become clear to those of ordinary skill in the art after perusal of this application. Accordingly, the present embodiments are to be considered as illustrative and not restrictive, and the invention is not to be limited to the details given herein, but may be modified within the scope and equivalents of the appended claims.

We claim:

1. A method performed by a processing device to provide a summary of patient healthcare information to an electronic health record, the method comprising:
receiving, by the processing device, electronic information indicating that a healthcare provider accessed an electronic health record of the patient;
receiving, by the processing device, electronic information indicating a health plan associated with the patient;
selecting from a plurality of routing identifiers associated with a plurality of processing devices, by the processing device, a routing identifier associated with another processing device to include in a request for the summary of patient healthcare information in response a health plan identifier included in the electronic information indicating the health plan;
transmitting, by the processing device, the request for the summary of patient healthcare information to another processing device having healthcare information of the patient;
receiving, by the processing device, the summary of patient healthcare information from another processing device; and
transmitting, by the processing device, the summary of patient healthcare information to the electronic health record.

2. The method of claim 1, wherein the electronic information indicating that the healthcare provider accessed the electronic health record includes information indicating that the healthcare provider entered a diagnosis of the patient and the summary of patient healthcare information is based on that diagnosis.

3. The method of claim 1, wherein the summary of patient healthcare information includes one or more of a diagnosis, a test, a treatment and a follow-up to be performed on the patient.

4. The method of claim 1, wherein the electronic information indicating that a health care provider accessed the electronic health record also includes patient information including one or more of a member number in the health plan, a patient's name, a patient date of birth, an electronic health record identifier, an electronic health record patient identifier, an electronic health record healthcare provider identifier and a diagnosis code.

5. The method of claim 4, wherein the electronic information indicating a health plan associated with a patient includes a health plan name and a health plan identifier.

6. The method of claim 5, wherein the selecting includes comparing the health plan identifier with a plurality of health plan identifiers in a database before selecting from the plurality of routing identifiers, wherein the selecting does not occur when there is not a match between the health plan identifier and one of the plurality of health plan identifiers.

7. The method of claim 6, further comprising:
transmitting, by the processing device, electronic information that indicates that there is not a health plan match when there is not a match between the health plan identifier and one of the plurality of health plan identifiers.

8. The method of claim 1, wherein transmitting the summary of patient information further includes transmitting one or more of an electronic health record identifier, an electronic health record patient identifier and an electronic health record healthcare provider identifier associated with the summary of patient information.

9. A processing device to provide a summary of healthcare information of a patient to an electronic health record, the processing device comprising:
at least one storage device to store a plurality of routing identifiers used to request a summary of patient healthcare information;
at least one processor, coupled to the storage device;
at least one storage device to store executable machine readable instructions for controlling the processor; and
at least one processor is operative with the executable machine readable instructions to:
receive electronic information indicating that a healthcare provider entered a diagnosis into the electronic health record of the patient;
receive electronic information indicating a health plan associated with the patient;
select from the plurality of routing identifiers a routing identifier to include in a request for a summary of patient healthcare information in response to the reception of the information indicating the entering of the diagnosis and the health plan;
transmit the request for the summary of patient healthcare information to a processing device having healthcare information of the patient;
receive the summary of patient healthcare information from the processing device having the healthcare information; and
transmitting the summary of patient healthcare information to the electronic healthcare record.

10. The processing device of claim 9, wherein the summary of patient healthcare information includes one or more of a diagnosis, a test, a treatment and a follow-up to be performed on the patient, wherein the summary of patient healthcare information also indicates the out of pocket cost for the patient for the one or more the test, treatment and follow-up.

11. The processing device of claim 10, wherein the electronic information indicating that a healthcare provider entered a diagnosis into the electronic health record of a patient includes patient information including one or more of a member number in the health plan, a patient's name, a patient date of birth, an electronic health record identifier, an electronic health record patient identifier, an electronic health record healthcare provider identifier and a diagnosis code.

12. The processing device of claim 11, wherein the electronic information indicating a health plan associated with a patient includes a health plan name and a health plan identifier.

13. The processing device of claim 12, wherein at least one processor is operative with the executable machine readable instructions to:
compare the health plan identifier with a plurality of health plan identifiers stored in the at least one storage device, wherein the selection of the routing identifier does not occur when there is not a match between the health plan identifier and one of the plurality of health plan identifiers.

14. The processing device of claim 13, wherein at least one processor is operative with the executable machine readable instructions to:
transmit electronic information that indicates that there is not a health plan match when there is not a match between the health plan identifier and one of the plurality of health plan identifiers.

15. The processing device of claim 11, wherein the at least one processor is operative with the executable machine readable instructions to:
transmit the electronic healthcare record healthcare provider identifier and electronic healthcare record patient identifier with the associated summary of patient healthcare information.

16. A system to provide a summary of healthcare information of a patient to an electronic health record, the system comprising:
a first processing device including a processor to execute machine readable instructions stored in a storage device, the first processing device to provide an electronic healthcare record for a patient;
a second processing device including a processor to execute machine readable instructions stored in a storage device, the second processing device to store a summary of healthcare information of the patient; and
a third processing device including a processor to execute machine readable instructions stored in a storage device, the third processing device to provide the summary of healthcare information of the patient to the first processing device from the second processing in response to a diagnosis code being entered into the electronic healthcare record at the first processing device,
wherein the diagnosis code is transferred from the first processing device to the third processing device after the diagnosis code is entered into the electronic healthcare record,
wherein the third processing device requests the summary of healthcare information of the patient from the second processing device in response to receiving the diagnosis code from the first processing device.

17. The system of claim 16, wherein the summary of patient healthcare information includes one or more one or more of a diagnosis, a scheduled medical test, a treatment and a follow-up to be performed on the patient, wherein the summary of patient healthcare information also indicates the out of pocket cost of the patients for the one or more the scheduled medical test, treatment and follow-up.

18. The system of claim 17, wherein the third processing device requests the summary of healthcare information of the patient by generating a request message including a routing identifier selected from a plurality of routing identifiers associated with a plurality of health plan identifiers stored in the storage device of the third processing device.

19. The system of claim 18, wherein a health plan identifier is transferred from the first processing device to the third processing device, and wherein the health plan identifier is compared to the plurality of health plan identifiers in order to select the routing identifier

20. The system of claim 19, wherein the routing identifier indicates where to locate the second processing device.
